(19) United States
(12) Patent Application Publication
(10) Pub. No.: US 2018/0276302 A1
(43) Pub. Date: Sep. 27, 2018

(54) SEARCH PROVIDER SELECTION USING STATISTICAL CHARACTERIZATIONS

(71) Applicant: SAP Portals Israel Ltd., Ra'Anana (IL)

(72) Inventors: Roman Talyansky, Haifa (IL); Vitaly Vainer, Kfar Saba (IL); Oleg Kossoy, Netanya (IL)

(21) Appl. No.: 15/468,580

(22) Filed: Mar. 24, 2017

(51) Int. Cl. G06F 17/30

(52) U.S. Cl. CPC G06F 17/30867; G06F 17/3053; G06F 17/30011

(57) ABSTRACT

A system determines user context (UC) keywords associated with a context of a user of a computing device based on extracting words from context items associated with the user. The system also determines search provider (SP) keywords for each of a plurality of search providers, the SP keywords associated with a respective textual content (e.g., documents) of each of the plurality of search providers. Determining the SP keywords for a search provider may include calculating a term frequency-inverse document frequency (tf-idf) score for each word of each content item of the textual content of the search provider. The system then selects a search provider (or several) from the plurality of search providers based on a number of UC keywords that match the search provider's SP keywords being greater than a threshold number. The system then generates a query for the selected search provider based on the matching UC keywords.

### TECHNICAL FIELD

The present disclosure relates generally to optimizing processes of searching for electronic information and, in a particular embodiment, to selecting a limited number of the most appropriate search provider(s) to access the electronic information.

### BACKGROUND

The proliferation of electronic information available via the Internet (and other electronic networks) has resulted in many users relying on search providers (e.g., content and a corresponding search engine that provides a search interface to the content) to access such information. Users may search for information on the Internet using two basic types of search providers: general search providers that do not limit their searches to any particular area of interest (e.g. www.Google.com); and vertical search providers (also known as specialty or specific search providers) that focus on a specific type of data and/or area of interest. Some examples of vertical search providers are: WebMD Search, for health information (www.webmd.com/search); Scirus, for scientific information (www.scirus.com); and Hipmunk, for travel information (www.hipmunk.com).

General search providers may crawl (e.g., retrieve) and index (e.g., interpret and organize) Internet content (e.g., web pages: hypertext documents connected to the World Wide Web) relating to every kind of subject. Vertical search providers are more selective about the Internet content they crawl and index, and this may enable better quality search results in their respective areas of specialization. For example, vertical search providers may achieve higher updating rates based on a smaller content size with respect to a general search provider. Furthermore, vertical search providers often present results from the Invisible Web (also referred to as Deep Web or Hidden Web), which is a portion of the World Wide Web not “seen” (e.g., crawled and indexed) by general search providers.

Conventional approaches for using search providers to access electronic information on the Internet are tedious and inefficient. For example, two potential issues that often arise from dealing with multiple search providers are: how can Internet users know about the limitations and capabilities of available search providers; and how can the user know which search provider(s) are the best choices (e.g., so as to avoid having to query every search provider) for each search context?

### BRIEF DESCRIPTION OF DRAWINGS

The present disclosure is illustrated by way of example and not limitation in the figures of the accompanying drawings, in which like references indicate similar elements and in which:

FIG. 1 is a block diagram of a data flow of a system, consistent with some embodiments, configured to use statistical characterizations to select a limited number of search providers to access information.

FIG. 2 is a ladder diagram illustrating a method, consistent with some embodiments, for using statistical characterizations to select a limited number of search providers to access information.

FIG. 3 is a flow diagram illustrating a method, consistent with some embodiments, for using statistical analysis to select a number of words to characterize a search provider's content.

FIG. 4 is a flow diagram illustrating a method, consistent with some embodiments, for using statistical characterizations to select a limited number of search providers to access information.

FIG. 5 is a flow diagram illustrating a method, consistent with some embodiments, for using statistical characterizations to rank search results received from a number of search providers.

FIG. 6 is a block diagram illustrating an example of a software architecture that may be installed on a machine, according to some example embodiments.

FIG. 7 illustrates a diagrammatic representation of a machine in the form of a computer system within which a set of instructions may be executed for causing the machine to perform any one or more of the methodologies discussed herein.

### DETAILED DESCRIPTION

Content recommendation systems recommend information items such as text documents, business objects, or blog posts. A content recommendation system may analyze a textual component of user context content (e.g., recent emails and/or upcoming meetings) and extract user context (UC) keywords from the user context content. The extracted UC keywords may then be used to build a set of search queries for search providers. The queries are then submitted to the search providers, the search providers return the search results, and, finally, the search results may be ranked before being suggested to the user as the recommended content items.

The content recommendation system may interact with multiple search providers. Each search provider may be a vertical search provider having content of a specific type. For example, a search provider for travel management content provides access to travel management business objects, while a search provider for enterprise purchase systems may provide access to purchase-oriented business objects. When UC keywords are extracted from user context content, as noted above, each of the UC keywords may be associated with one or more different topics (e.g., travel management or purchase orders). Since it is not efficient or productive to generate travel management-oriented queries for an enterprise purchase systems search provider, each of the UC keywords may be matched to a particular vertical search provider so that each search provider receives only queries that are appropriate for its specific content type, and the number of generated queries is limited by focusing only on search providers with an appropriate content. A textual component of the vertical search provider content may be characterized using search provider (SP) keywords (as explained below) in order to match the search provider content type to the one or more different topics associated with each of the extracted UC keywords by matching each of the UC keywords to SP keywords.

The search provider content may be characterized using statistical methods such as determining a term frequency-inverse document frequency (tf-idf) score for each content item in a search provider's content. The tf-idf score is based on two assumptions. The first assumption deals with term (e.g., word) frequencies in a content item (e.g., document); terms that appear more frequently in the document are more important in this document than terms that appear less frequently in the same document. The number of occurrences of term t in document d is called term frequency and is denoted: tf_{d}(t). The second assumption relates to a corpus (e.g., a collection of documents); terms that occur in fewer documents in the corpus are more important than terms that occur in more documents. For example the word “the” occurs almost in all online Cable News Network (CNN) newspaper articles for the year 2013 and therefore it may be assumed to carry very little semantic significance. However, the word “software” occurs in far fewer CNN articles for the year 2013 articles and can be assumed to carry more semantic significance.

Therefore, an idf may be defined as follows, with C being a corpus and t being a term:

$${idf}_{c} ( t ) = log \frac{\vert C \vert}{1 + \vert \{ d ∈ C \text{:} t is in d \} \vert} .$$

Then, the tf-idf of a term t in document d and a corpus C may be defined as:

tf-idf_{d,C}(t)=tf_{d}(t)−idf_{C}(t).

Finally the SP key words for a search provider may be defined as terms identified in the search providers content, wherein the identified terms have high tf-idf scores (for example, scores that exceed some specified threshold value or some predetermined number of the top scores).

In an embodiment, each search provider is characterized in terms of its specific textual content by a set of SP keywords that have the highest tf-idf scores within the search provider content. The tf part of the tf-idf score for a word may be calculated as explained above wherein terms with higher tf value are more significant within a content item. The idf part of the tf-idf score for a word may be calculated with respect to a large generic corpus that represents a language as a whole, e.g., Wikipedia (http://en.wikipedia.org), or the content of a general search provider, e.g., Google. The content of each vertical search provider is not used as the corpus because the content would provide a mono-generic corpus, consisting of a single type of text, representing some element of a language, e.g., financial reports or, at most, a multi-generic corpus representing a few related elements of the language, e.g., financial reports and purchase-oriented business objects. The use of such a limited corpus could bias the tf-idf score for the specific content type of each vertical search provider. However, using a large generic corpus that represents the whole (or at least a large percentage of the whole, e.g., 90% or more) language allows the idf part of the tf-idf score for a word to represent the extent to which the word is semantically significant in the language. Therefore, the tf-idf score of a word will characterize the extent to which the word is significant within a vertical search provider's specific content.

Once a set of words with high tf-idf scores (per content item in a search provider content) are identified, a set of SP keywords may be determined for each vertical search provider by aggregating the words with high tf-idf scores of individual content items in that search provider. For example, an average of all tf-idf scores for words over all content items in a search provider may be calculated and a predetermined number of the words with the highest average scores may be selected. This set of selected words may be extracted from the search-provider content to form its SP keyword set to characterize a textual part of this search provider's content.

When a set of UC keywords is extracted from user context content items, the UC key words may be grouped according to the search providers by using the SP keywords in the following way. For each UC keyword, search providers that have this UC keyword among their SP keywords (e.g., the UC keyword matches an SP keyword) are identified. Then the matched UC keywords are associated with the corresponding identified search providers so that a set of UC keywords associated with a vertical search provider may be used to construct queries for this search provider. In an embodiment, queries are only constructed if a threshold number of UC keywords (e.g., one or more) match an SP keyword of a vertical search provider.

In an embodiment, more than a specified number of vertical search providers have SP keywords that match the threshold number of UC keywords. In this situation, the vertical search providers may be ranked according to how many of their respective SP keywords match one of the UC keywords. Then the specified number of the highest ranked search providers may be selected and queries may be generated for each of the selected search providers based on the respective matching UC keywords for each of the selected search providers.

In an embodiment, the generated queries are then submitted to the selected search providers and, subsequently, results are received from each of the selected search providers. The results themselves may also be ranked according to tf-idf scores of matching UC keywords occurring in each result and then the results may be presented, in order based on their respective ranks, on a display of a computing device of the user.

### System Architecture

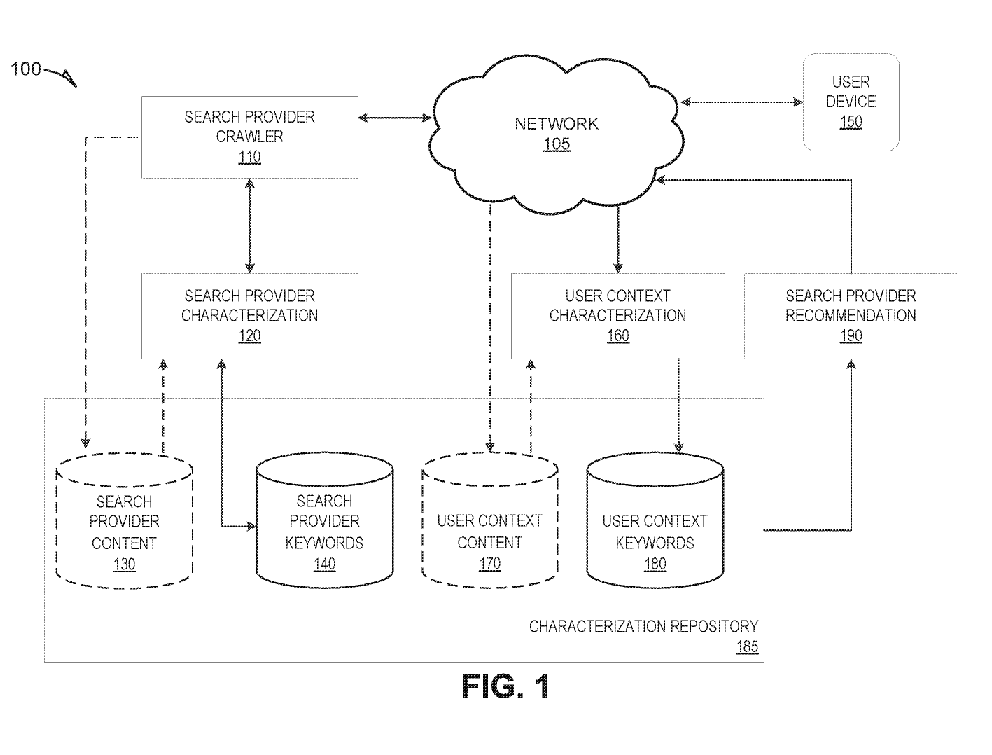

FIG. 1 is a block diagram of a data flow of a system 100, consistent with some embodiments, configured to use statistical characterizations to select a limited number of search providers to access information.

The block diagram of FIG. 1 illustrates how a system 100 builds its operating characterization repository 185 of UC keywords 180 and SP keywords 140. In order to characterize search providers, the system 100 operates a search provider crawler 110 that continuously traverses a network 105 (e.g., the World Wide Web) for content associated with search providers. The search provider crawler 110 may use well known methods in order to detect the search provider content (e.g., web pages) and may also fetch the content for storage in search provider content 130 if the size of the search provider content is compatible with the storage capacity of the characterization repository 185. The detected search provider content may then be forwarded (from the search provider crawler 110 or the search provider content 130) to a search provider (SP) characterization module 120, where a series of operations (as described below) are performed in order to extract a set of SP keywords 140 from the search provider content.

Content items associated with a context of a user of user device 150 may be accessible via a user context (UC) characterization module 160 over the network 105 or may be transmitted directly to the user context content 170 of the characterization repository 185 by the user device 150 (e.g., via a context application on the user device 150) over the network 105. The UC characterization module 160 may detect user context content items (e.g., e-mails or calendar appointments) on the user device 150 and/or may also fetch the user context content items from the user context content 170 of the characterization repository 185. The UC characterization module 120 may then perform a series of operations (as described below) in order to extract a set of UC keywords 180 from the user context content items.

After the SP keywords 140 and UC keywords 180 have been determined for each of the search providers and the user respectively, one or more search provider may be selected (e.g., from a plurality of search providers) based on a number of UC keywords 180 that match the one or more search provider's SP keywords 140 being greater than a threshold number. For example, every search provider that has SP keywords 140 that match at least two UC keywords 180 may be selected. It is noted that a thesaurus may be used to add words with similar meanings to the words in the set of UC keywords 180 and to the words in the sets of SP keywords 140 in order to increase the likelihood of finding matching words when comparing the UC keywords 180 to the SP keywords 140. Queries may then be generated, by SP recommendation module 190, for the selected search providers based on the matching UC keywords 180 so that only relevant queries are sent to each search provider, over network 105, and only a limited number of queries are generated since every search provider is unlikely to be selected.

In an embodiment, determining the UC keywords for the user of user device 150 comprises using the UC characterization module 160 to extract the UC keywords 180 from the user context content items associated with the user (e.g., items stored in user context content 170). As noted above, the user context content items may also be accessed from the user device 150 and may comprise one or more of an e-mail, an application, a location, a date, and/or a calendar entry. The extracted UC keywords 180 characterize the context of the user (for example, the name of a friend in an e-mail, a day or month in date, or an address in a calendar entry).

In an embodiment, the plurality of search providers for which SP keywords 140 are extracted comprises a plurality of vertical search providers which focus on providing access to a specific type of content. The SP keywords 140 for each such search provider (of the plurality of search providers) may be determined (e.g., by SP characterization module 120) via operations including: calculating a tf-idf score for each word of each content item of the textual content of the search provider (as explained above): calculating an average of the calculated tf-idf scores for each word; and selecting a predetermined number of the words with the highest average tf-idf scores as the SP keywords 140 for the search provider.

As noted above, the tf portion of the tf-idf score, for each word of each content item of the search provider content, represents a number of occurrences of the word in the content item; and the idf portion of the tf-idf score, for each word of each content item of the search provider content, represents an inverse value of how often the word occurs, at least once, in content items of a textual content of a general search provider or general database (e.g., Google or Wikipedia).

In an embodiment, more than a specified number of the plurality of search providers have SP keywords 140 that match more than the threshold number of UC keywords 180. In this situation, the plurality of search providers may be ranked (e.g., by SP recommendation module 190) according to how many of their respective SP keywords 140 match one of the UC keywords 180. The specified number (or another designated number) of highest ranked search providers may then be selected and queries may be generated (e.g., by SP recommendation module 190) for each of the selected search providers based on the respective matching UC keywords 180 for each of the selected search providers.

In an embodiment, the generated queries may then be submitted (e.g., by SP recommendation module 190) to the selected search providers over network 105. Search results may then be received by user device 150 from each of the selected search providers. Alternatively, the results may be received by SP recommendation module 190, which may rank the results according to tf-idf scores of any matching UC keywords 180 occurring in each result (e.g., tf-idf scores of a matching UC keyword 180 that appears in a document returned as a search result). The SP recommendation module 190 (over network 105) may then present the results in order based on their respective ranks on a display of the user device 150.

### Methods

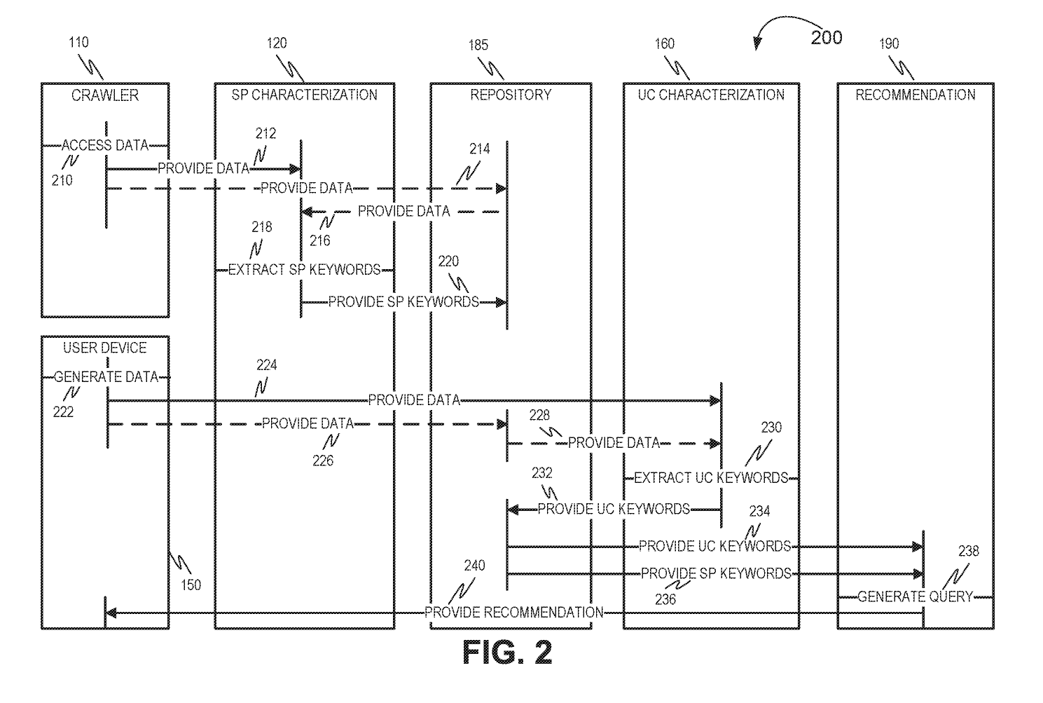

FIG. 2 is a ladder diagram illustrating a method 200, consistent with some embodiments, for using statistical characterizations to select a limited number of search providers to access information. The elements in FIG. 2 include elements from FIG. 1, which are labeled with the same identifiers.

At operation 210, a search provider crawler 110 accesses content of a plurality of vertical search providers. At operation 212, the search provider crawler 110 provides the content to the SP characterization module 120. Alternatively, at operation 214, the search provider crawler 110 provides the content to the characterization repository 185 (e.g., search provider content 130) for storage and, at operation 216, the characterization repository 185 provides the content to the SP characterization module 120. At operation 218, the SP characterization module 120 determines SP keywords 140 for each search provider of the plurality of search providers. The SP keywords are associated with a respective textual content of each search provider (e.g., words that have a high tf-idf score within the search provider's content). At operation 220, the SP characterization module 120 provides the SP keywords 140 to the characterization repository 185.

At operation 222, the user device 150 generates a user context content item such as an e-mail, text message, or calendar entry. It is noted that generating such user context content items may simply involve receiving data such as an e-mail, which involves storing the e-mail to a local memory and generating a representation of the e-mail on the user device 150. At operation 224, the user device 150 provides the user context content items to the UC characterization module 160. Alternatively, at operation 226, the user device 150 provides the user context content items to the characterization repository 185 (e.g., user context content 170) for storage and, at operation 228, the characterization repository 185 provides the user context content items to the UC characterization module 160. At operation 230, the UC characterization module 160 determines UC keywords 180 for the context of the user of user device 150. The UC keywords are associated with a textual content of the user context content items (e.g., words that indicate a context of the user). At operation 232, the UC characterization module 160 provides the UC keywords 180 to the characterization repository 185.

At operation 234, the characterization repository 185 provides the UC keywords 180 to the SP recommendation module 190 so that a recommendation can be made to the user of user device 150. At operation 236, the characterization repository 185 provides the SP keywords 140 to the SP recommendation module 190 so that the SP recommendation module 190 may match them to the UC keywords 180. It is noted that the characterization repository 185 may provide the SP keywords 140 to the SP recommendation module 190 only in response to a request from the SP recommendation module 190. In this way, if the SP recommendation module 190 has recently selected search providers for a same set of UC keywords 180, it may be able to retrieve suitable SP keywords from a cache of data associated with recent (e.g., within a threshold amount of time) recommendations it has made.

At operation 238, the SP recommendation module 190 generates queries for search providers that have been selected from the plurality of search providers based on a number of UC keywords 180 that match the selected search provider's SP keywords being greater than a threshold number (e.g., 1, 2, 2, . . . ). The SP recommendation module 190 generates the queries for each selected search provider based on the matching UC keywords for each search providers SP keywords. The queries are submitted to the corresponding search providers by the SP recommendation module 190 and the results (e.g., returned by each search provider to the SP recommendation module 190) are provided to the user device 150 as recommendations at operation 240.

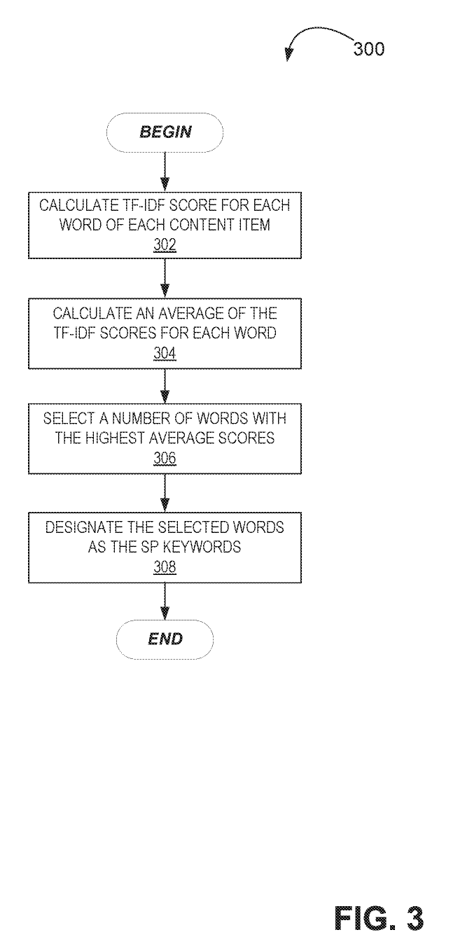

FIG. 3 is a flow diagram illustrating a method 300, consistent with some embodiments, for using statistical analysis to select a number of words to characterize a search provider's content. The elements in FIG. 3 are described below with respect to the elements from FIG. 1, which are labeled with the same identifiers.

The SP keywords 140 for each search provider, of the plurality of search providers, are determined, at operation 302, by calculating (e.g., using SP characterization module 120) a tf-idf score for each word of each content item of the textual content of each search provider. As explained above, the tf-idf score is calculated for each word of each content item of the content of each search provider with respect to a generic corpus of texts that represent the entire language (e.g., English). At operation 304, an average of the tf-idf scores for each word of each content item of the content of each search provider is calculated. At operation 306, a predetermined number of the words with the highest tf-idf scores are selected for each search provider and, at operation 308, these selected words are designated as the SP keywords 140 for each of the corresponding search providers.

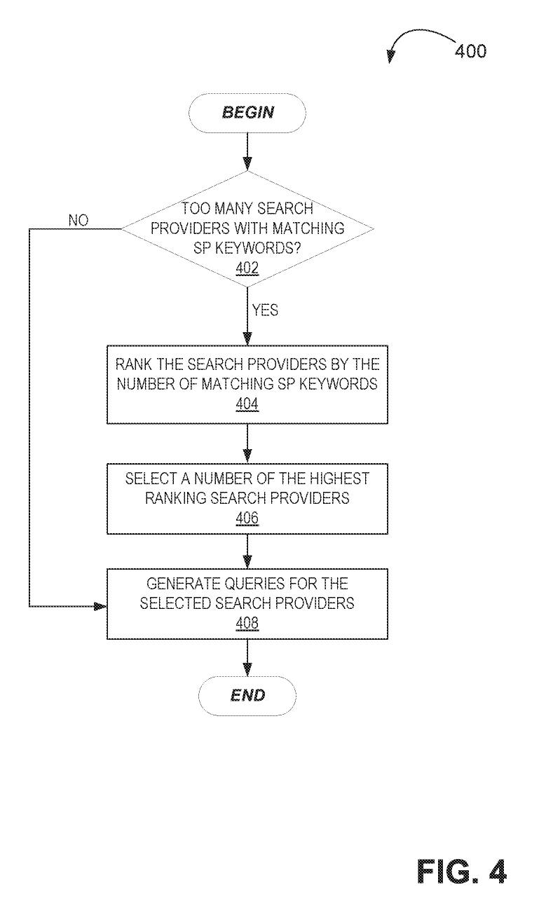

FIG. 4 is a flow diagram illustrating a method 400, consistent with some embodiments, for using statistical characterizations to select a limited number of search providers to access information. The elements in FIG. 4 are described below with respect to the elements from FIG. 1, which are labeled with the same identifiers.

At operation 402, it is determined (e.g., by SP recommendation module 190) whether more than a specified number (e.g., 10) of the plurality of search providers have SP keywords 140 that match more than the threshold number of UC keywords 180 and, therefore, would be selected to be queried. If there are not more than the specified number of search providers with sufficient matching SP keywords 140, then the operations continue to operation 408, where all of the search providers with sufficient matching SP keywords are selected and queries are generated for these selected search providers. If there are more than the specified number of search providers with sufficient matching SP keywords, then the operations continue to operation 404, where all of the search providers with sufficient matching SP keywords 140 are ranked according to how many of their respective SP keywords 140 match one of the UC keywords.

At operation 406, a number (e.g., the specified number) of the highest ranked search providers are selected and, at operation 408, queries are generated for each of the selected search providers based on the respective matching UC keywords for each of the selected search providers.

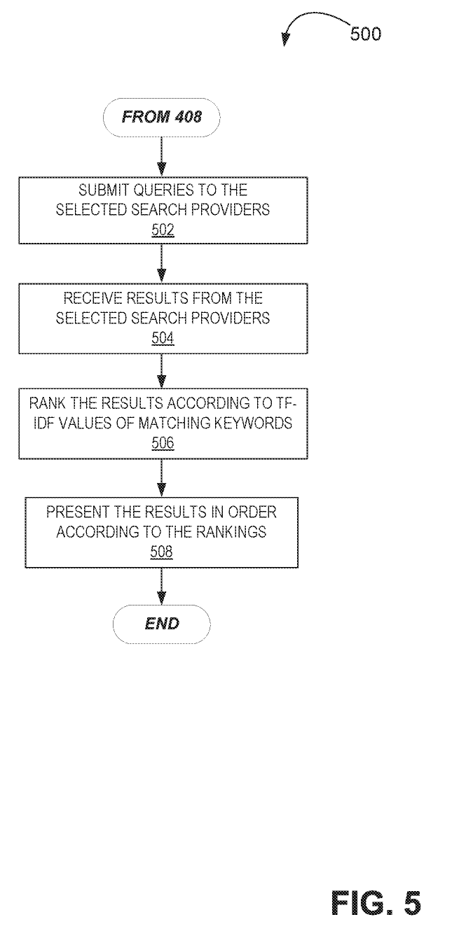

FIG. 5 is a flow diagram illustrating a method 500, consistent with some embodiments, for using statistical characterizations to rank search results received from a number of search providers. The elements in FIG. 5 are described below with respect to the elements from FIG. 1.

The operations of method 500 continue from operation 408 of FIG. 4. At operation 502, the generated queries are submitted (e.g., by SP recommendation module 190) to the selected search providers, e.g., over network 105. At operation 504, search results (e.g., in response to the queries) are received, e.g., by SP recommendation module 190. At operation 506, the received search result are ranked by SP recommendation module 190 according to tf-idf values (calculated as described above) of matching UC key words 180 that appear in each of the search results. For example, if a search provider SP keyword “money” matches a UC keyword, then a tf-idf value for the word money in each returned search result (e.g., a document) from a search provider would be used to rank the document. At operation 508, the returned search results may be presented on a display of user device 150 in an order that is based on the respective ranking of each of the search results.

### EXAMPLES

### Example 1

a system comprising a processor and a memory coupled to the processor, the memory including instructions which, when executed by the processor, cause the system to perform operations comprising: determining, using the processor, search provider (SP) keywords for each of a plurality of search providers, the SP keywords associated with a respective textual content of each of the plurality of search providers; determining, using the processor, user context (UC) keywords associated with a context of a user of a computing device; selecting a search provider from the plurality of search providers based on a number of UC keywords that match the search provider's SP keywords being greater than a threshold number; and generating, using the processor, a query for the selected search provider based on the matching UC keywords.

### Example 2

the system of example 1, wherein determining the UC keywords comprises extracting the UC keywords from context items associated with the user: and the context items comprise at least one of an e-mail, an application, a location, a date, or a calendar entry of the computing device.

### Example 3

the system of any of examples 1-2, further comprising a searchable database, wherein determining the SP keywords comprises using the processor to search the searchable database for the SP keywords.

### Example 4

the system of example 3, wherein the plurality of search providers comprises a plurality of vertical search providers and to determine the SP keywords for each search provider of the plurality of search providers the operations further comprise: calculating a term frequency-inverse document frequency (tf-idf) score for each word of each content item of the textual content of the search provider; calculating an average of the tf-idf scores for each word; selecting a predetermined number of the words with the highest average tf-idf scores as the SP keywords for the search provider; and storing the SP keywords in the searchable database.

### Example 5

the system of example 4, wherein the tf portion of the tf-idf score, for each word of each content item, represents a number of occurrences of the word in the content item; and the idf portion of the tf-idf score, for each word of each content item, represents an inverse value of how often the word occurs at least once in content items of a textual content of a general search provider or a general database.

### Example 6

the system of example 5, wherein more than a specified number of the plurality of search providers have SP keywords that match more than the threshold number of UC keywords, the operations further comprising: ranking the plurality of search providers according to how many of their respective SP keywords match one of the UC keywords: selecting the specified number of highest ranked search providers; and generating queries for each of the selected search providers based on the respective matching UC keywords for each of the selected search providers.

### Example 7

the system of example 6, the operations further comprising: submitting the queries to the selected search providers; receiving results from each of the selected search providers; ranking the results according to tf-idf scores of matching UC keywords occurring in each result; and presenting the results in order based on their respective ranks on a display of the computing device.

### Example 8

a computerized method comprising: determining search provider (SP) keywords for each of a plurality of search providers, the SP keywords associated with a respective textual content of each of the plurality of search providers; determining user context (UC) keywords associated with a context of a user of a computing device; selecting a search provider from the plurality of search providers based on a number of UC keywords that match the search provider's SP keywords being greater than a threshold number: and generating a query for the selected search provider based on the matching UC keywords.

### Example 9

the method of example 8, wherein determining the UC keywords comprises extracting the UC keywords from context items associated with the user; and the context items comprise at least one of an e-mail, an application, a location, a date, or a calendar entry of the computing device.

### Example 10

the method of any of examples 8-9, wherein determining the SP keywords comprises using the processor to search a searchable database for the SP keywords.

### Example 11

the method of example 10, wherein the plurality of search providers comprises a plurality of vertical search providers and to determine the SP keywords for each search provider of the plurality of search providers the method further comprises: calculating a term frequency-inverse document frequency (tf-idf) score for each word of each content item of the textual content of the search provider; calculating an average of the tf-idf scores for each word; selecting a predetermined number of the words with the highest average tf-idf scores as the SP keywords for the search provider: and storing the SP keywords in the searchable database.

### Example 12

the method of example 11, wherein the tf portion of the tf-idf score, for each word of each content item, represents a number of occurrences of the word in the content item; and the idf portion of the tf-idf score, for each word of each content item, represents an inverse value of how often the word occurs at least once in content items of a textual content of a general search provider or a general database.

### Example 13

the method of example 12, wherein more than a specified number of the plurality of search providers have SP keywords that match more than the threshold number of UC keywords, the method further comprising: ranking the plurality of search providers according to how many of their respective SP keywords match one of the UC keywords: selecting the specified number of highest ranked search providers: and generating queries for each of the selected search providers based on the respective matching UC keywords for each of the selected search providers.

### Example 14

the method of example 13, further comprising: submitting the queries to the selected search providers; receiving results from each of the selected search providers: ranking the results according to tf-idf scores of matching UC keywords occurring in each result: and presenting the results in order based on their respective ranks on a display of the computing device.

### Example 15

A non-transitory machine-readable storage medium storing instructions which, when executed by at least one processor of a machine, cause the machine to perform operations comprising: determining search provider (SP) keywords for each of a plurality of search providers, the SP keywords associated with a respective textual content of each of the plurality of search providers; determining user context (UC) keywords associated with a context of a user of a computing device: selecting a search provider from the plurality of search providers based on a number of UC keywords that match the search provider's SP keywords being greater than a threshold number: and generating a query for the selected search provider based on the matching UC keywords.

### Example 16

the machine-readable storage medium of example 15, wherein determining the UC keywords comprises extracting the UC keywords from context items associated with the user; and the context items comprise at least one of an e-mail, an application, a location, a date, or a calendar entry of the computing device.

### Example 17

the machine-readable storage medium of any one of examples 15-16, wherein determining the SP keywords comprises using the processor to search a searchable database for the SP keywords.

### Example 18

the machine-readable storage medium of example 17, wherein the plurality of search providers comprises a plurality of vertical search providers and to determine the SP keywords for each search provider of the plurality of search providers the operations further comprise: calculating a term frequency-inverse document frequency (tf-idf) score for each word of each content item of the textual content of the search provider; calculating an average of the tf-idf scores for each word; selecting a predetermined number of the words with the highest average tf-idf scores as the SP keywords for the search provider; and storing the SP keywords in the searchable database

### Example 19

the machine-readable storage medium of example 18, wherein the tf portion of the tf-idf score, for each word of each content item, represents a number of occurrences of the word in the content item; and the idf portion of the tf-idf score, for each word of each content item, represents an inverse value of how often the word occurs at least once in content items of a textual content of a general search provider or a general database.

### Example 20

the method of example 19, wherein more than a specified number of the plurality of search providers have SP keywords that match more than the threshold number of UC keywords, the operations further comprising: ranking the plurality of search providers according to how many of their respective SP keywords match one of the UC keywords; selecting the specified number of highest ranked search providers; and generating queries for each of the selected search providers based on the respective matching UC keywords for each of the selected search providers.

### Example 21

the machine-readable storage medium of example 19, the operations further comprising: submitting the queries to the selected search providers; receiving results from each of the selected search providers; ranking the results according to tf-idf scores of matching UC keywords occurring in each result; and presenting the results in order based on their respective ranks on a display of the computing device.

### Example 22

the non-transitory machine-readable storage medium of example 20 further storing instructions which, when executed by the at least one processor, cause the machine to perform operation comprising the operations of the method of any of examples 13-19.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application programming interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-5 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the subject matter in different contexts from the disclosure contained herein.

### Software Architecture

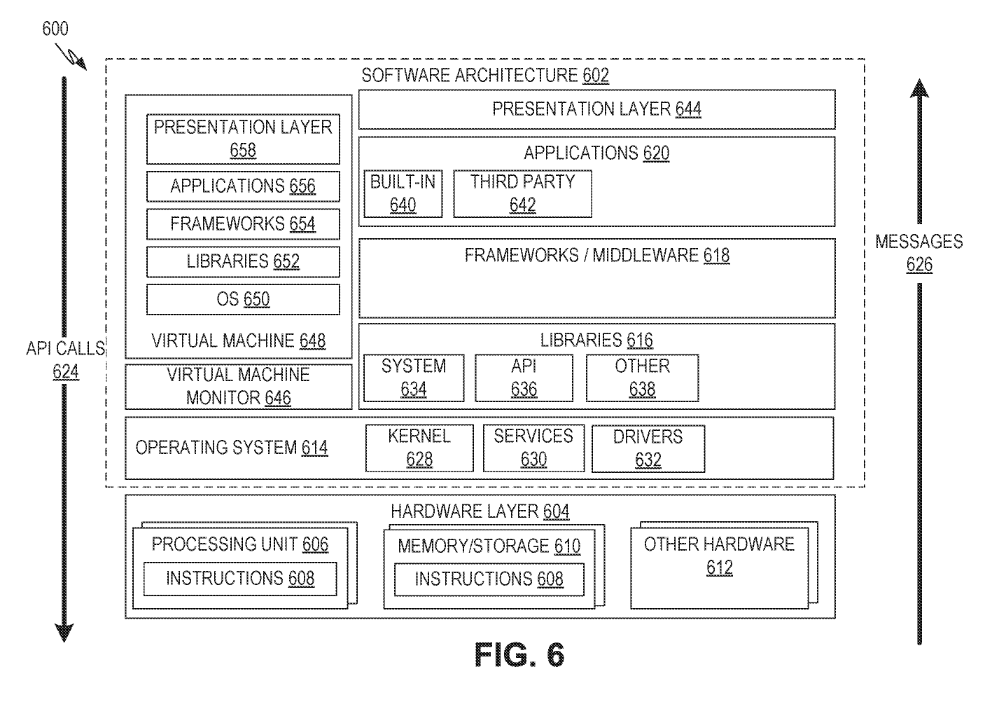

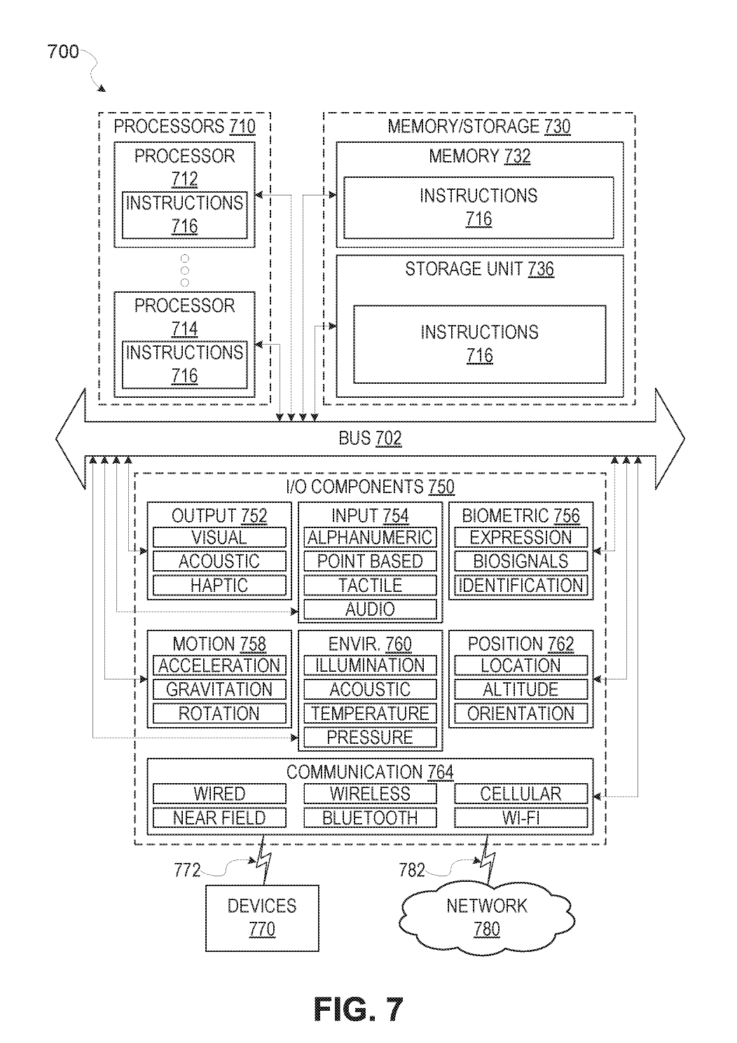

FIG. 6 is a block diagram 600 illustrating an example of a software architecture 602 that may be installed on a machine, according to some example embodiments. FIG. 6 is merely a non-limiting example of a software architecture, and it will be appreciated that many other architectures may be implemented to facilitate the functionality described herein. The software architecture 602 may be executing on hardware such as a machine 700 of FIG. 7 that includes, among other things, processors 710, memory/storage 730, and I/O components 750. A representative hardware layer 604 is illustrated and can represent, for example, the machine 700 of FIG. 7. The representative hardware layer 604 comprises one or more processing units 606 having associated executable instructions 608. The executable instructions 608 represent the executable instructions of the software architecture 602, including implementation of the methods, modules, and so forth of FIGS. 1-5. The hardware layer 604 also includes memory or storage modules 610, which also have the executable instructions 608. The hardware layer 604 may also comprise other hardware 612, which represents any other hardware of the hardware layer 604, such as other hardware illustrated as part of machine 700.

In the example architecture of FIG. 6, the software architecture 602 may be conceptualized as a stack of layers, where each layer provides particular functionality. For example, the software architecture 602 may include layers such as an operating system 614, libraries 616, frameworks/middleware 618, applications 620, and a presentation layer 644. Operationally, the applications 620 or other components within the layers may invoke API calls 624 through the software stack and receive a response, returned values, and so forth (illustrated as messages 626) in response to the API calls 624. The layers illustrated are representative in nature, and not all software architectures have all layers. For example, some mobile or special purpose operating systems may not provide a frameworks/middleware 618 layer, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 616 may provide a common infrastructure that may be utilized by the applications 620 and/or other components and/or layers. The libraries 616 typically provide functionality that allows other software modules to perform tasks in an easier fashion than by interfacing directly with the underlying operating system 614 functionality (e.g., kernel 628, services 630, or drivers 632). The libraries 616 may include system libraries 634 (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media format such as MPEG4, H.264, MP3, AAC. AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks 618 (also sometimes referred to as middleware) may provide a higher-level common infrastructure that may be utilized by the applications 620 or other software components/modules. For example, the frameworks 618 may provide various graphic user interface (GUI) functions, high-level resource management, high-level location services, and so forth. The frameworks 618 may provide a broad spectrum of other APIs that may be utilized by the applications 620 and/or other software components/modules, some of which may be specific to a particular operating system or platform.

The applications 620 include built-in applications 640 and/or third-party applications 642. Examples of representative built-in applications 640 may include, but are not limited to, a contacts application, a browser application, a book reader application, a location application, a media application, a messaging application, or a game application. The third-party applications 642 may include any of the built-in applications 640, as well as a broad assortment of other applications. In a specific example, the third-party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 642 may invoke the API calls 624 provided by the mobile operating system, such as the operating system 614, to facilitate functionality described herein.

The applications 620 may utilize built-in operating system functions (e.g., kernel 628, services 630, or drivers 632), libraries (e.g., system libraries 634, API libraries 636, and other libraries 638), or frameworks/middleware 618 to create user interfaces to interact with users of the system. Alternatively, or additionally, in some systems, interactions with a user may occur through a presentation layer, such as the presentation layer 644. In these systems, the application/module “logic” can be separated from the aspects of the application/module that interact with the user.

Some software architectures utilize virtual machines. In the example of FIG. 6, this is illustrated by a virtual machine 648. A virtual machine creates a software environment where applications/modules can execute as if they were executing on a hardware machine (e.g., the machine 700 of FIG. 7, for example). A virtual machine 648 is hosted by a host operating system (e.g., operating system 614) and typically, although not always, has a virtual machine monitor 646, which manages the operation of the virtual machine 648 as well as the interface with the host operating system (e.g., operating system 614). A software architecture executes within the virtual machine 648, such as an operating system 650, libraries 652, frameworks/middleware 654, applications 656, and a presentation layer 658. These layers of software architecture executing within the virtual machine 648 can be the same as corresponding layers previously described or may be different.

### Machine Architecture and Machine-Readable Medium

FIG. 7 illustrates a diagrammatic representation of a machine in the form of a computer system within which a set of instructions may be executed for causing the machine to perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example the instructions 716 may cause the machine 700 to execute the method 700 of FIG. 7. Additionally, or alternatively, the instructions 716 may implement FIGS. 1-5, and so forth. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory/storage 730, and I/O components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 712 and a processor 714 that may execute the instructions 716. The term “processor” is intended to include multi-core processors that may comprise two or more independent processors (sometimes referred to as “cores”) that may execute instructions contemporaneously. Although FIG. 7 shows multiple processors 710, the machine 700 may include a single processor with a single core, a single processor with multiple cores (e.g., a multi-core processor), multiple processors with a single core, multiple processors with multiples cores, or any combination of processors and cores.

The memory/storage 730 may include a memory 732, such as a main memory, or other memory storage, and a storage unit 736, both accessible to the processors 710 such as via the bus 702. The storage unit 736 and the memory 732 store the instructions 716 embodying any one or more of the methodologies or functions described herein. The instructions 716 may also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of the processors 710 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), or any suitable combination thereof. The term “machine-readable medium” should be taken to include a single medium or multiple media (e.g., a centralized or distributed database, or associated caches and servers) able to store the instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine (e.g., processors 710), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 762 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, Near Field Communication (NFC) components, Bluetootht components (e.g., Bluetooth® Low Energy). Wi-Fit components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internmet Protocol (IP) geolocation, location via Wi-Fi®) signal triangulation, location via detecting an NFC beacon signal that may indicate a particular location, and so forth.

### Transmission Medium

In various example embodiments, one or more portions of the network 780 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Filt network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (IxRTI), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., hypertext transfer protocol (HTTP)). Similarly, the instructions 716 may be transmitted or received using a transmission medium via the coupling 772 (e.g., a peer-to-peer coupling) to the devices 770. The term “transmission medium” shall be taken to include any intangible medium that is capable of storing, encoding, or carrying the instructions 716 for execution by the machine 700, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising a processor and a memory coupled to the processor, the memory including instructions which, when executed by the processor, cause the system to perform operations comprising:
determining, using the processor, search provider (SP) keywords for each of a plurality of search providers, the SP keywords associated with a respective textual content of each of the plurality of search providers;
determining, using the processor, user context (UC) keywords associated with a context of a user of a computing device;
selecting a search provider from the plurality of search providers based on a number of UC keywords that match the search provider's SP keywords being greater than a threshold number; and
generating, using the processor, a query for the selected search provider based on the matching UC keywords.

2. The system of claim 1, wherein:
determining the UC keywords comprises extracting the UC keywords from context items associated with the user; and
the context items comprise at least one of an e-mail, an application, a location, a date, or a calendar entry of the computing device.

3. The system of claim 1, further comprising a searchable database, wherein determining the SP keywords comprises using the processor to search the searchable database for the SP keywords.

4. The system of claim 3, wherein the plurality of search providers comprises a plurality of vertical search providers and to determine the SP keywords for each search provider of the plurality of search providers the operations further comprise:
calculating a term frequency-inverse document frequency (tf-idf) score for each word of each content item of the textual content of the search provider;
calculating an average of the tf-idf scores for each word;
selecting a predetermined number of the words with the highest average tf-idf scores as the SP keywords for the search provider; and
storing the SP keywords in the searchable database.

5. The system of claim 4, wherein:
the tf portion of the tf-idf score, for each word of each content item, represents a number of occurrences of the word in the content item; and
the idf portion of the tf-idf score, for each word of each content item, represents an inverse value of how often the word occurs at least once in content items of a textual content of a general search provider or a general database.

6. The system of claim 5, wherein more than a specified number of the plurality of search providers have SP keywords that match more than the threshold number of UC keywords, the operations further comprising:
ranking the plurality of search providers according to how many of their respective SP keywords match one of the UC keywords;
selecting the specified number of highest ranked search providers; and
generating queries for each of the selected search providers based on the respective matching UC keywords for each of the selected search providers.

7. The system of claim 6, the operations further comprising:
submitting the queries to the selected search providers;
receiving results from each of the selected search providers;
ranking the results according to tf-idf scores of matching UC keywords occurring in each result; and
presenting the results in order based on their respective ranks on a display of the computing device.

8. A computerized method comprising:
determining search provider (SP) keywords for each of a plurality of search providers, the SP keywords associated with a respective textual content of each of the plurality of search providers;
determining user context (UC) keywords associated with a context of a user of a computing device;
selecting a search provider from the plurality of search providers based on a number of UC keywords that match the search provider's SP keywords being greater than a threshold number; and
generating a query for the selected search provider based on the matching UC keywords.

9. The method of claim 8, wherein:
determining the UC keywords comprises extracting the UC keywords from context items associated with the user; and
the context items comprise at least one of an e-mail, an application, a location, a date, or a calendar entry of the computing device.

10. The method of claim 8, wherein determining the SP keywords comprises using the processor to search a searchable database for the SP keywords.

11. The method of claim 10, wherein the plurality of search providers comprises a plurality of vertical search providers and to determine the SP keywords for each search provider of the plurality of search providers the method further comprises:
calculating a term frequency-inverse document frequency (tf-idf) score for each word of each content item of the textual content of the search provider;
calculating an average of the tf-idf scores for each word;
selecting a predetermined number of the words with the highest average tf-idf scores as the SP keywords for the search provider; and
storing the SP keywords in the searchable database.

12. The method of claim 11, wherein:
the TF portion of the tf-idf score, for each word of each content item, represents a number of occurrences of the word in the content item; and
the IDF portion of the tf-idf score, for each word of each content item, represents an inverse value of how often the word occurs at least once in content items of a textual content of a general search provider or a general database.

13. The method of claim 12, wherein more than a specified number of the plurality of search providers have SP keywords that match more than the threshold number of UC keywords, the method further comprising:
ranking the plurality of search providers according to how many of their respective SP keywords match one of the UC keywords;
selecting the specified number of highest ranked search providers; and
generating queries for each of the selected search providers based on the respective matching UC keywords for each of the selected search providers.

14. The method of claim 13, further comprising:
submitting the queries to the selected search providers;
receiving results from each of the selected search providers;
ranking the results according to tf-idf scores of matching UC keywords occurring in each result; and
presenting the results in order based on their respective ranks on a display of the computing device.

15. A non-transitory machine-readable storage medium storing instructions which, when executed by at least one processor of a machine, cause the machine to perform operations comprising:
determining search provider (SP) keywords for each of a plurality of search providers, the SP keywords associated with a respective textual content of each of the plurality of search providers;
determining user context (UC) keywords associated with a context of a user of a computing device;
selecting a search provider from the plurality of search providers based on a number of UC keywords that match the search provider's SP keywords being greater than a threshold number; and
generating a query for the selected search provider based on the matching UC key words.

16. The non-transitory machine-readable storage medium of claim 15, wherein:
determining the UC keywords comprises extracting the UC keywords from context items associated with the user; and
the context items comprise at least one of an e-mail, an application, a location, a date, or a calendar entry of the computing device.

17. The non-transitory machine-readable storage medium of claim 15, wherein the plurality of search providers comprises a plurality of vertical search providers to determine the SP keywords for each search provider of the plurality of search providers the operations further comprise:
calculating a term frequency-inverse document frequency (tf-idf) score for each word of each content item of the textual content of the search provider;
calculating an average of the tf-idf scores for each word; and
selecting a predetermined number of the words with the highest average tf-idf scores as the SP keywords for the search provider.

18. The non-transitory machine-readable storage medium of claim 17, wherein:
the tf portion of the tf-idf score, for each word of each content item, represents a number of occurrences of the word in the content item; and
the idf portion of the tf-idf score, for each word of each content item, represents an inverse value of how often the word occurs at least once in content items of a textual content of a general search provider or a general database.

19. The non-transitory machine-readable storage medium of claim 18, wherein more than a specified number of the plurality of search providers have SP keywords that match more than the threshold number of UC keywords, the operations further comprising:
ranking the plurality of search providers according to how many of their respective SP keywords match one of the UC keywords;
selecting the specified number of highest ranked search providers; and
generating queries for each of the selected search providers based on the respective matching UC keywords for each of the selected search providers.

20. The non-transitory machine-readable storage medium of claim 19, the operations further comprising:
submitting the queries to the selected search providers;
receiving results from each of the selected search providers;
ranking the results according to tf-idf scores of matching UC keywords occurring in each result; and
presenting the results in order based on their respective ranks on a display of the computing device.
